(19) United States
(12) Patent Application Publication
(10) Pub. No.: US 2006/0215494 A1
(43) Pub. Date: Sep. 28, 2006

(54) Autolocating underwater beacon and method for deployment thereof

(76) Inventor: Hubert Thomas, Le Tholonet (FR)

Correspondence Address: SUGHRUE MION, PLLC, 2100 PENNSYLVANIA AVENUE, N.W., SUITE 800, WASHINGTON, DC, 20037, US

(21) Appl. No.: 11/193,374

(22) Filed: Aug. 1, 2005

(30) Foreign Application Priority Data
Aug. 6, 2004 (FR) 0408707

(51) Int. Cl. G01S 3/80

(52) U.S. Cl. 367/128

(57) ABSTRACT

An underwater acoustic beacon includes a subsystem for determining geographical position, and a transmitter for transmitting coordinates of the position at the point of impact when the beacon is deployed.

### BACKGROUND OF THE INVENTION

The invention relates to the field of underwater positioning techniques using radio and acoustic waves. It more particularly concerns underwater acoustic beacons deployed through the air or by surface crafts. They are intended to be anchored to the sea-floor after having had their geographical co-ordinates determined without human intervention. The invention also seeks to provide a method of deployment of said underwater acoustic beacons which includes a step of localizing their geographical co-ordinates.

1. Technical Field

The technical field of the invention is navigation systems intended for positioning and guidance of divers or underwater vehicles with the use of acoustic waves and exploiting information resulting from radio signal receivers.

2. State of the Art Review

Various techniques are used in the field of underwater positioning and guidance. They use in general propagation of acoustic waves.

A first method, development in the 1970's is described in Thomson-CSF patent EP 0.084.468. It consists in equipping the mobile to be localized with an acoustic transmitter-receiver. The mobile interrogates at regular intervals the beacons laid on the sea-bed. The measurement of the acoustic signal transit time, to and from the beacon, knowing the speed of sound in water, allows determination of the distances to the mobile-beacons. If the co-ordinates of the beacons are known, the mobile is then localized at the point of intersection of spheres centered on the beacons and having radius equal to the travel times divided by twice the sound velocity and corrected, if necessary, for possible delay. This well-known technique is called “Long Base Line”. Its implementation requires the use of a ship for deploying the beacons in the water; and also to calibrate the beacon array. These operations make it necessary to equip the ship with an acoustic transceiver and equipment for determining the geographical co-ordinates of the ship. Such operations take several hours in general and require a specialized personnel highly qualified.

A second method, conceived in 1985 by Dr. Tom ROSSBY, well-known oceanographer, uses synchronous acoustic transmitters attached to the sea-bed (Cf T. Rossby and Al: The SOFAR/RAFOS System—Newspaper off Atmospheric and Oceanic Technology, Flight 3 p 672-679, 1986 and Pascale LHERMINIER Doctorate thesis supported at the University of Paris 6 on Jun. 18, 1998, pages 117-118). It is the case of RAFOS transmitters marketed by Webb Research company in the United States, Sparton in Canada and by ORCA Instrumentation in France. The underwater mobile is located by measuring on board of the mobile the times of arrival of the acoustic pulses coming from the various transmitters.

More complex systems corresponding to the second method are manufactured and commercialized by NAUTRONIX (Refer to patent applications WO 02.077.663 and WO 02.077.664) under the trade mark “NasNet”. They require a ship for their deployment, their calibration and to monitor the drift of the clocks embedded in the seabed stations. The original NAUTRONIX system was designed to integrate a device to measure the offset of the transmitter head with regard to its base plate, which offset could be due to the effect of the current or tide. This allows an improvement in overall accuracy.

Further, a third method consists in deploying acoustic transmitters immersed vertically below some buoys and having, with respect to the underwater environment, a behavior similar to GPS satellites. This method is described in the U.S. Pat. No. 5,119,341.

A fourth method, described in French patent FR 2.806.167, consists in embarking on board the underwater vehicle to locate an acoustic source transmitting non periodic signals and to deploy on the working area one or more points of measurement equipped with an acoustic receiver, a time reference and some means of localization of the aforesaid points of measurement. Lastly, one transmits towards a processing center information resulting from the various points of measurement for calculation of the co-ordinates of the mobile. This method does not allow the mobile to know its position in geographical co-ordinates.

The above solutions cannot be implemented by an aircraft, nor by a ship in the case for example the working zone would be contaminated. Indeed, the equipment used in the first and the second methods requires the presence of a ship to carry out the calibration operations, in geographical co-ordinates, of the field of beacons. The third method requires the presence of buoys on the surface which, in certain circumstances, can prove to be not covert enough. In addition, the acoustic emissions require having on board the buoys a source of energy which makes the buoys undesirably large. The fourth method, if it allows a control and command center to know the position of the underwater mobiles, does not give to the underwater vehicles any information relating to their positions and thus, the required guidance function towards a point of known co-ordinates cannot be achieved.

Generally, the problem to solve is the installation, in a hostile environment, if possible without human intervention, of a device made up of acoustic beacons simultaneously making it possible for one or more underwater mobiles to locate themselves in geographical co-ordinates in order to reach waypoints which are known in an absolute geographic reference.

### SUMMARY OF THE INVENTION

A first aspect of the present invention is a method of deployment of one or more underwater acoustic beacons, comprising the steps of:

loading on board an aircraft 1 (manned or unmanned) one or more of the aforesaid autolocated underwater acoustic beacons,

dropping the beacon(s) above the underwater mobiles mission area,

autolocating one or more of the underwater acoustic beacons 6, according to any of claims 1 to 10,

memorizing onboard the aircraft 1 the co-ordinates of the beacons as received during the fall 2, up to the point of impact 4 with water,

releasing 7 an anchoring device 20 allowing immobilization of the beacon above the sea-bed at a predetermined altitude,

activating the electronic circuits 33 for sequencing the acoustic emissions of the aforesaid the beacon,

downloading in an embedded memory on board underwater mobiles 13 the co-ordinates of the points of impact of the beacons and their particular acoustic characteristics.

A second aspect of the present invention resides in a device made up of one or more underwater acoustic beacons characterized in that they include at least:
a device for determining local geographical co-ordinates 17, and,
a transmission device of said co-ordinates 24, and,
a waterproof enclosure 22 supporting an acoustic transducer 18 and associated electronics circuitry 19, and,
having a floatation 23, and an anchoring device 20 of the aforesaid enclosure.

### BRIEF DESCRIPTION OF THE DRAWINGS

The invention will be more clearly understood from the following detailed description in conjunction with the accompanying drawings, in which:

FIG. 1 represents an overall picture of the deployment of one or more underwater acoustic beacons according to the invention, and

FIG. 2 is a view of the various subsets composing the autolocalized underwater acoustic beacon, and

FIG. 3 is a synoptic view of the electronic subsets of the beacon, and

FIG. 4 represents a perspective view of the beacon and its devices for reduction of sonar signature.

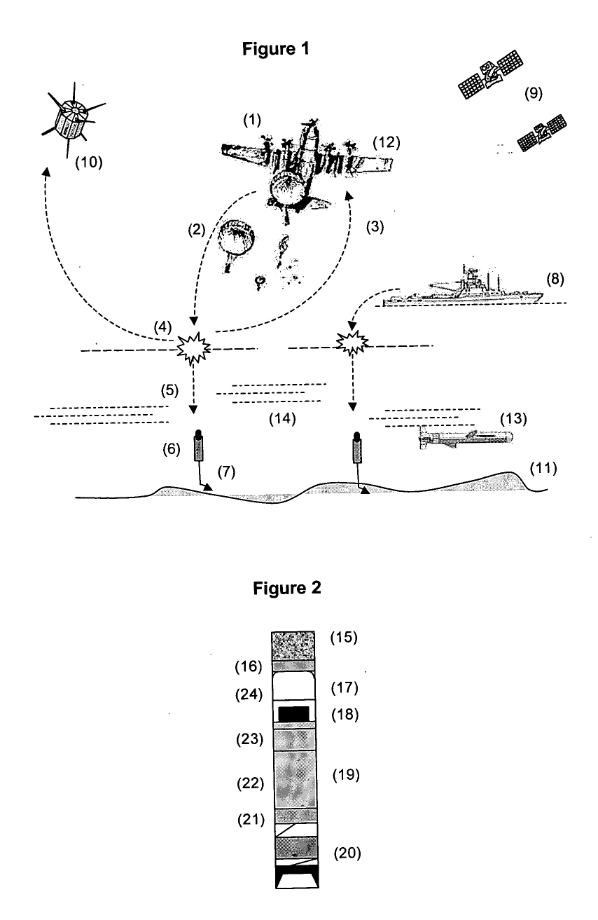

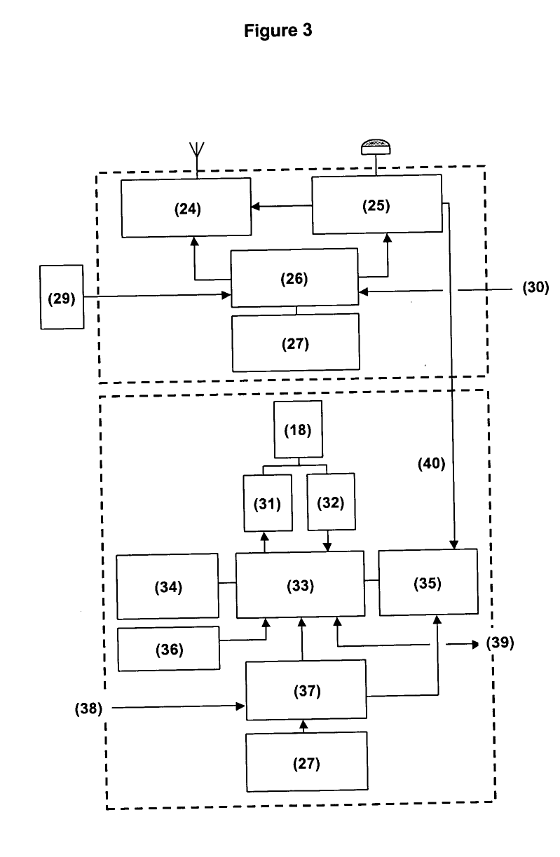

### DETAILED DESCRIPTION OF THE INVENTION

In a first embodiment, the auto localized underwater acoustic beacon comprises modules and devices assembled within an envelope allowing it to be dropped from an aircraft in flight. This is illustrated in FIG. 2:

A module for auto localization 17 includes a receiver of radio positioning signals transmitted by satellites (For example: GPS, Glonass or Galiléo). This receiver can be powered by the electric energy source 27 before or during the drop when activated by the activation module receiving an external command or upon receiving a signal coming from a device 16 activating a parachute, such as a pressure switch and its integrated logic 29. Such an equipment, miniaturized, is known under the trade mark “CYPRESS”. Said receiver of radio positioning signals is connected to a radio transmission device activated at least at the time of the final phase of the fall and until the point of impact 4. A radio receiver 12 located aboard the plane is used to collect the geographical co-ordinates of the point of impact. They will be downloaded later with the specific parameters of each beacon in the memory of the navigation and guidance calculator of the underwater mobiles. An optional connection 40 makes it possible to ensure the synchronization of the acoustic module's clock 35 with the time reference of the radio positioning system 9.

During its fall 2, or during the underwater transit phase 5, a device 21 allows the separation of the anchoring module 20 made up of a line and a drop weight made of a high density material, such as lead, having a function of grapnel. At the end of the underwater transit, the watertight container 22 containing the acoustic module 19 is positioned a few meters directly above the drop weight because of existence of a positive buoyancy 23.

The acoustic module 19 consists of a transducer 18 which can be made of piezoelectric ceramic material. This acoustic transducer can be used in emission and reception modes. Logical circuits 33, such as a micro-controller, sequence the acoustic pulse emissions, through the transmit power circuits 31 either on reception of an interrogation acoustic signal coming from the mobile and detected by receiver 32, or through a signal coming from clock 35. In this later case, the acoustic emissions are controlled by the clock 35 which is an ultra stable clock, having a very low drift. The clock signal coming from the radio positioning receiver 25 is used to synchronize the beacon internal clock 35 to a common time reference. A memory 34 contains the parameters being used to define the shape and the duration of the emitted and received acoustic signals; e.g., their repetition rate. An optional pressure sensor 36, makes it possible to broadcast the immersion of the beacon. Optional electrodes 38 are used to authorize the acoustic emissions only when the beacon is immersed. The optional energy management device 37 is used to switch the beacon into sleep mode in order to save energy when not in the active phases of the mission. Interface 39 allows testing of the correct operation of the beacon by an external means; as well as the configuration of its specific running parameters.

Beacon 6 has a means, such as a deployable airfoil 15, making it possible to slow down and/or guide the aforementioned beacon during its fall. It has an automatic device 29 for opening the airfoil or parachute 15, at low altitude above the water level.

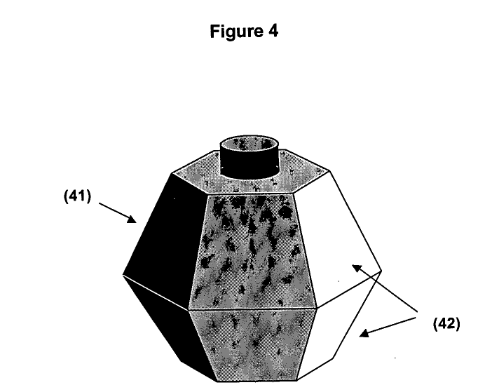

As shown in FIG. 4, the beacon according to the invention has, on its periphery, means 42 for reduction of its signature with respect to active sonar.

The communication channel 24 of the beacon co-ordinates with either a radio link, a satellite communication link, or an infra-red or laser data transmission link.

The device for determining local geographical co-ordinates 25 is a satellite positioning receiver (GPS, GLONASS or GALILEO), or any other means of localization.

The beacon according to the invention can integrate a pressure sensor 36 and means of coding of the emissions for sending, by an acoustic channel, the telemetry of, e.g., the depth of immersion of the beacon.

For reasons of covertness, it is interesting to design the beacon with a form resulting in reducing its signature with respect to active sonar. Such a form 42 is presented in FIG. 4. For this purpose, the envelope of the beacon may also be covered with absorbing materials 41.

According to other modes of implementation of the method of the invention, the vehicle from which the beacon is deployed is not an aircraft, but a ship, or a submarine, with or without crew.

One stresses that one can install, in the compartment of carrier 1, a relay transmitter of radio positioning signals to allow fast start-up of the radio positioning receiver before dropping the beacon. Alternatively, the beacon localization means in geographical co-ordinates could be installed on board the launcher itself.

Advantageously, specific buoys, a boat or an underwater vehicle, could be deployed on the mission area, at a later stage, to improve the localization accuracy of the beacons once anchored on the bottom. In particular, to compensate for the drift, due to the current, during the underwater transit phase.

According to a particular mode of realization, transducer 18 is used in a responder mode. This means that it starts its emissions on reception of an interrogation signal coming from the underwater mobile. In another mode, it is only used to emit signals according to a specific sequence controlled by circuits 33 synchronized by signals generated by the internal clock 35.

Use of the device and process of this invention as described herein leads to the advantages that:

No human intervention is necessary to determine with precision the co-ordinates of the beacon, those co-ordinates being associated with the co-ordinates of the beacon point of impact with the water surface. Being deployed in shallow water, the possible drift due to current between the surface and the seabed is negligible in comparison with the precision required by the system. For missions requiring a high degree of accuracy, buoys, such as those described in U.S. Pat. No. 5,579,285, can be deployed onsite for a few minutes, the time necessary to acquire and retransmit the useful information by radio towards the data processing center.

As a consequence, the beacon described herein is truly a beacon that locates itself geographically.

The above mentioned subsets composing the beacon allow, according to the state of the art, the manufacture of a beacon weighing only a few kilograms. Thus, one can build a plurality of beacons and can easily be in several units and deployed by an air drone or a remotely controlled boat.

The speed of deployment is another important aspect of the invention. The beacon because of its auto localization process maybe used as soon as dropped in the water.

Being able to emit signals only upon interrogation, the beacons object of this invention have a low power consumption, compared to the method described in the American patent U.S. Pat. No. 5,119,341 or in the WO 02.077.663 and WO 02.077.664 patent applications.

1. An underwater acoustic beacon characterized in that it includes at least:
a device for determining geographical co-ordinates 17,
a transmission device for transmitting said co-ordinates 24,
a waterproof enclosure 22 supporting an acoustic transducer 18,
associated electronics circuitry 19, and,
a floatation 23, and an anchoring device 20 of said enclosure.

2. An underwater acoustic beacon according to claim 1, wherein the acoustic transducer (18) is used in emission and reception.

3. An underwater acoustic beacon according to claim 1, wherein the acoustic emissions are controlled by an ultra stable clock 35.

4. An underwater acoustic beacon according to claim 1, wherein the acoustic emissions are controlled by an ultra stable clock 35, and further wherein the clock signal output of a radio positioning receiver 25 is used to synchronize a beacon internal clock 35 to share an absolute reference of time.

5. An underwater acoustic beacon according to claim 4, further comprising means for slowing down or guiding the beacon during its fall, such as an opening airfoil 15.

6. An underwater acoustic beacon according to claim 1, wherein it has a device 29 for automatically opening the airfoil at low altitude, above water.

7. An underwater acoustic beacon according to claim 1, wherein it has on its periphery a device 42 to reduce its signature with respect to active sonar.

8. An underwater acoustic beacon according to claim 1, wherein the channel of communication 24 of the beacon co-ordinates is a radio link, a communication satellite link, an infra-red or laser channel.

9. An underwater acoustic beacon according to claim 1, wherein the device for determining local geographical coordinates 25 is a satellites positioning receiver (GPS, GLONASS or GALILEO).

10. An underwater acoustic beacon according to claim 1, wherein it integrates a pressure sensor 36 and a means for coding of the emissions for transmitting by acoustic channel telemetry data representing the value of immersion of the beacon and/or its geographical co-ordinates.

11. A method of deployment of underwater acoustic beacons, comprising the following operations:
providing at least one autolocalized underwater acoustic beacons 6 according to claim 1,
loading on board an aircraft 1 inhabited or not one or more of the aforesaid autolocalized underwater acoustic beacons,
dropping said beacons above an underwater mobiles mission area,
memorizing onboard the aircraft 1 the co-ordinates of the beacons as received during the fall 2, up to the point of impact 4 with water,
releasing 7 an anchoring device 20 allowing positioning the beacon above the sea-bed at a predetermined altitude,
activating the electronic circuits 33 for sequencing the acoustic emissions of the aforesaid beacon, and
downloading in an embedded memory on board underwater mobiles 13 the co-ordinates of the points of impact of the beacons and their particular acoustic characteristics.

12. A process of deployment of underwater acoustic beacons according to claim 11, wherein the means of deployment is not an aircraft; but, a ship 8 or a submarine, with or without crew.

13. A process of deployment of underwater acoustic beacons, according to claim 11, further comprising a relay transmitter, in the compartment of the carrier 1, for transmitting radio positioning signals to allow the start-up of the radio positioning receiver before dropping of the beacon.

14. A process of deployment of underwater acoustic beacons according to claim 11, wherein the means for determining local geographical co-ordinates is located on board the launcher.

15. A process of deployment of underwater acoustic beacons according to claims 11, characterized by the fact that specific buoys, a boat or an underwater vehicle are used at a later stage to improve the precision of localization of beacons once anchored.

16. A process of deployment of underwater acoustic beacons, according to claim 12, further comprising a relay transmitter, in the compartment of the carrier 1, for transmitting radio positioning signals to allow the start-up of the radio positioning receiver before dropping of the beacon.
